(19) United States
(12) Patent Application Publication
(10) Pub. No.: US 2002/0108670 A1
(43) Pub. Date: Aug. 15, 2002

(54) High purity chemical container with external level sensor and removable dip tube

(76) Inventors: John Eric Baker, Temecula, CA (US); Lee Senecal, Vista, CA (US); Robert Sam Zorich, Carlsbad, CA (US); David Allen Roberts, Encinitas, CA (US)

Correspondence Address: AIR PRODUCTS AND CHEMICALS, INC., PATENT DEPARTMENT, 7201 HAMILTON BOULEVARD, ALLENTOWN, PA, 181951501

(21) Appl. No.: 09/781,855

(22) Filed: Feb. 12, 2001

(51) Int. Cl. B67C 3/00

(52) U.S. Cl. 141/18; 141/198; 141/95

(57) ABSTRACT

A container for high purity chemicals having an externally placed level sensor to avoid contamination of such chemical and for ready serviceability and a removeable liquid out diptube to facilitate cleaning during refilling or refurbishing. The container can have a valved inlet and outlet and can be constructed of stainless steel which is electropolished.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The electronic device fabrication industry requires various liquid chemicals as raw materials or precursors to fabricate integrated circuits and other electronic devices. This need arises from the requirement to dope semiconductors with various chemicals to provide the appropriate electrical properties in the semiconductor for transitors and gate oxides, as well as circuits requiring various metals, barrier layers, vias. Additionally, dielectric layers are needed for capacitors and interlayer dielectric requirements. Fabrication requiring subtractive technologies require resists, planarization chemistries and etchants.

All of the chemicals that are used in these applications are required in high purity conditions to meet the stringent requirements of the electronic fabrication industry imposed by the extremely fine line width and high device densities in current and future electronic devices being fabricated with those chemicals.

A part of the effort to provide high purity chemicals is the design and structure of the containers and systems which delivery such chemicals to the reactor or furnaces where the electronic devices are being fabricated. The purity of the chemicals can be no better than the containers in which they are stored and the systems through which they are dispensed.

In addition, it is important to monitor the quantity of high purity chemical available during its use in the electronic device fabrication process. Electronic devices are fabricated in quantities of several hundred at a time per semiconductor wafer, with the size of individual wafers being processed expected to be larger in future fabrication processes. This makes the value of the yield of electronic devices being processed on wafers very high, resulting in considerable cost if processing or fabrication occurs when the high purity chemical is unavailable inadvertently. Thus, the electronic fabrication industry has used monitoring of high purity chemical quantity a part of their scheme in their fabrication processes.

To address the issues of purity and monitoring of chemical quantity available for use, the industry has made various attempts to achieve those goals.

U.S. Pat. No. 5,199,603 discloses a container for organometallic compounds used in deposition systems wherein the container has inlet and outlet valves and a diptube for liquid chemical dispensing through the outlet. However, no level sensor is provided and the diptube terminates inside the container.

U.S. Pat. No. 5,562,132 describes a container for high purity chemicals with diptube outlet and internal float level sensor. The diptube is connected to the integral outlet valve. However, the diptube is not readily serviceable during refill or refurbishing of the container and the internal float level sensors are known particle generators for the high purity chemicals contained in the container.

U.S. Pat. No. 4,440,319 shows a container for beverages in which a diptube allows liquid dispensing based upon a pressurizing gas. The diptube may reside in a well to allow complete dispensing of the beverage. Level sense is not taught and the diptube is not readily removed or refurbished.

U.S. Pat. No. 4,053,085 discloses an arrangement for sealing a tube containing corrosive chemicals which uses two concentric washer seals of elastomeric materials. One seal is resilient and one is corrosion resistant. The use of metallic seals is not proposed.

U.S. Pat. No. 5,663,503 describes an ultrasonic sensor, which is known to be used to detect liquid presence in a vessel. Invasive and non-invasive sensors are described.

The shortcomings of the prior art in addressing the goals of purity and level sensing are overcome by the present invention, which provides high purity containment, ease of cleaning during refill or refurbishing and avoidance of contamination or particle generation during level sensing, as well as avoidance of atmospheric contamination during any changeout or repair of the level sensing device. Other advantages of the present invention are also detailed below.

### BRIEF SUMMARY OF THE INVENTION

The present invention is a container for high purity chemicals having a metallic shell, an inlet, an outlet, a level sensor on an external surface of the shell for determining the amount of high purity chemical in the container and a diptube connected to the outlet through which high purity chemical can be dispensed from the container by connection to a downstream high purity chemical delivery system.

The present invention is also a container for high purity chemicals having a metallic shell with an external surface comprising a top surface, a side surface and a bottom surface, a valved inlet, a valved outlet, an ultrasonic level sensor removeably affixed to an external surface of the shell for determining the amount of high purity chemical in the container and a diptube removably connected to the outlet through which high purity chemical can be dispensed from the container by connection to a downstream high purity chemical delivery system.

The present invention is further a container for high purity liquid chemical having a metallic shell with an external surface comprising a top surface, a side surface and a bottom surface, a pneumatically valved inlet, a pneumatically valved outlet, a charge of high purity liquid chemical, an ultrasonic level sensor removeably affixed to an external bottom surface of the shell for determining the amount of high purity chemical in the container and a diptube removably connected to the outlet through which high purity liquid chemical can be dispensed from the container by connection to a downstream high purity chemical delivery system.

### BRIEF DESCRIPTION OF SEVERAL VIEWS OF THE DRAWINGS

FIG. 1 is a schematic perspective view of a container outfitted in accordance with one embodiment of the present invention with a partial section showing a bottom surface.

FIG. 2 is a schematic perspective view of a container outfitted in accordance with another embodiment of the present invention with a partial section showing a bottom surface.

FIG. 3A is a schematic perspective view of a container outfitted in accordance with a further embodiment of the present invention with a partial section showing a bottom surface, with FIG. 3B showing an elevation partial sectional view of part 44, and FIG. 3C showing an elevation partial sectional view of an embodiment of the present invention that does not require an elastomeric O-ring.

FIG. 4 is a schematic perspective view of a container outfitted in accordance with another embodiment of the present invention with a partial section showing a bottom surface.

FIG. 5A is a schematic elevation view of a container outfitted in accordance with a further embodiment of the present invention with a partial section showing a bottom surface, with FIG. 5B showing an elevation partial sectional view of parts 50, 62 and 16. FIG. 5C is plan view of container 10 showing the placement of the sensor 50 relative to the main orifice 34.

FIG. 6A is a schematic perspective view of a container outfitted in accordance with a preferred embodiment of the present invention with a partial section showing a bottom surface, with FIG. 6B showing an elevation partial sectional view of parts 14 and 66. FIG. 6C is a closeup view of part 66 of FIG. 6B.

### DETAILED DESCRIPTION OF THE INVENTION

The present invention is directed to a container for high purity chemical, such as is required in fabrication of semiconductor devices, flat panel displays and electronic devices. Such fabrication typically requires high purity raw materials or chemical precursors. High purity in this context typically is above 99.9 wt. %, frequently at least 99.999 wt. % and most recently at least 99.9999 wt. % pure. To maintain such purity in containers of high purity chemicals, such as liquid chemicals of the class of tetraethylorthosilicate (TEOS), containers must be designed for exacting purity and inertness. Several parameters are appropriate, including elecropolished internal surfaces of high purity chemical wetted surfaces, inert materials of construction, such as stainless steel (316L) or quartz (depending on the chemical), absence of moving parts in the container, excellent inert seals, and ready accessibility of the container and its hardware during refilling and/or refurbishing.

Typically, high purity chemicals are today more frequently being delivered from on-site storage to the point of use at the furnace or tool, where they are utilized in a liquid state, to be vaporized or volatilized at the furnace or tool. This allows for greater throughput and more concise dispensing. One of the methods by which chemical is delivered from a container has been to use a diptube which is disposed in the chemical in the container. By applying a pressure to the head space of the container above the liquid level, the chemical is then expelled through the diptube out of the container into a secondary device.

This diptube has been a source of particle contamination in the past, because it is difficult to clean during the processing of containers to be filled with chemical. In the present invention, the diptube is designed to be removable from the container by utilizing a combination of an elastomer seal and a metal seal and/or a metal seal only. The diptube will be sealed into the container via an elastomer 0-ring or a metal seal, allowing chemical transfer through the tube and out of the container. In addition, the dip tube will be sealed against environmental contamination via an all metal seal. By making it removable from the container, the diptube can then be cleaned much more thoroughly. Not only does this allow for more thorough cleaning during container processing, it also allows secondary devices to be added to the diptube, such as a removable filter. It will also allow for alternate materials to be used for the diptube. This has application in a non-corrosive, all metal, coated container.

A non-intrusive level sensor that is attached to a non-wetted, permanent part of the container is also contemplated by the present invention. By “non-wetted, permanent part of the container”, the present invention refers to the level sensor being attached to a fixed, external surface or location on the container. The sensor would be attached one of two ways, permanently or so it is completely removable. By “completely removable”, the present invention contemplates a level sensor that can be removed from the container without compromising the integrity of the chemical or the container. Attaching the level sensor to a non-wetted external surface part of the container increases the integrity of the chemical. Making the level sensor removable from the container allows for easy replacement in the field if the level sensor does fail.

In the various embodiments of the present invention, specific locations and attachment techniques are described for the externally located ultrasonic level sensor and the diptube. However, this present invention contemplates a removable chemical delivery piping (“diptube”), and this may be installed in a number of equivalent fashions: a) from above the liquid level of the high purity chemical on the top surface of the container; b) from above the liquid level of the high purity chemical on the side surface of the container; c) from below the liquid level of the high purity chemical on the side surface of the container; d) from below the liquid level of the high purity chemical on the bottom surface of the container. Such top, side and bottom surfaces of the container constitute the external shell of the container. In some instances, the interface or intersecting seams of the various surfaces may be non-distinct, such as where the container has a generally spherical shape or the top and bottom surface represent a smooth curve continuation of the side surface or sidewall. However, the top surface is generally considered to be the area of the external surface which is at the highest point of the external surface of the container when it is in its normal service position. The bottom surface is the lowest most point of the external surface of the container when the container is in its normal service position. This excludes container skirts and chime rings. The external surfaces of the container are the outside non-wetted surfaces of the external shell. All such variations and combinations are appropriate to meet the objectives of the present invention for high purity service, ease of cleaning and refurbishing and when liquid delivery is contemplated, removal of substantially all of the content of a high purity chemical container.

The containers contemplated by the present invention include containers that directly feed the furnace or tool of an electronic device fabrication furnace or tool where the chemical is actually used, sometimes referred to as an ampoule, canister or process container; and also to containers which refill such earlier described container, sometimes referred to as bulk containers. The containers can be of any practical size, including from one or more liters to five or more liters. The size of the container is not critical. The piping or valved manifolds which deliver chemical to or from the containers are well known in the industry and are not described further, but they are typically referred to as chemical delivery systems and include, in addition to piping and valved manifolds, sources of pressurized inert gas (carrier or push gas), an automated control unit, source of pneumatic air to operate pneumatic valves, vent lines, purge lines, sources of vacuum, flow control and monitoring hardware and other attendent devices, which are not the topic of the present invention.

Chemicals that can be contained in the containers of the present invention may include: tetraethylorthosilicate (TEOS), borazine, aluminum trisec-butoxide, carbon tetrachloride, trichloroethanes, chloroform, trimethylphosphite, dichloroethylenes, trimethylborate, dichloromethane, titanium n-butoxide, dialkylsilane, diethylsilane, dibutylsilane, alkylsilanehydrides, hexafluoroacetylacetonatocopper(1)trimethylvinylsilane, isopropoxide, triethylphoshate, silicon tetrachloride, tantalum ethoxide, tetrakis(diethylamido)titanium, tetrakis(dimethylamido)titanium, bistertiarybutylamido silane, triethylborate, titanium tetrachloride, trimethylphosphate, trimethylorthosilicate, titanium ethoxide, tetramethyl-cyclo-tetrasiloxane, titanium n-propoxide, tris(trimethylsiloxy)boron, titanium isobutoxide, tris(trimethylsilyl)phosphate, 1,1,1,5,5,5-hexafluoro-2,4-pentanedione, tetramethylsilane, 1,3,5,7-tetramethylcyclotetrasiloxane and mixtures thereof.

In the described embodiments, specific locations and attachment techniques are described. However, the present invention contemplates various configurations of removable chemical delivery piping (“diptube”), and this may be installed in a number of equivalent fashions: a) from above the liquid level of the high purity chemical on top surface of the container; b) from above the liquid level of the high purity chemical on the side surface of the container; c) from below the liquid level of the high purity chemical on the side surface of the container; d) from below the liquid level of the high purity chemical on the bottom surface of the container. All such variations and combinations are contemplated.

Attachment of a diptube to the container of the present invention can be accomplished by several contemplated methods. The diptube is connected to the outlet by one of: a metal to metal seal using a VCR® gland; an elastomeric seal between an outer wall of the dip tube and an inner diameter of the outlet of the container; and, a metal to metal seal of the outlet and a flange on the diptube or other known connection devices for connecting a pipe to an outlet in the process chemistry industry.

In the versions of diptube sealing above, the O-ring seals are used with the diptube to allow chemical to flow from the container, through the diptube, out of the outlet and outlet valve when a pressure is applied to the container head space through the inlet and inlet valve using an inert pressurizing gas such as nitrogen or helium. The metal gasket seals out any contamination from the environment. Removable diptube attachment enhances the ability to clean or replace the diptube for high purity chemical service in the electronic fabrication industry. In addition, a removable diptube facilitates the use of additional high purity options, such as the placement of filters, getters, membranes, dosing dispensers and similar devices which may need service or replacement over the life of the container.

In these described embodiments, all components are manufactured from suitable metallic and non-metallic, compatible materials. In general, depending on the chemical in the container, this can include, but is not limited to, stainless steel (electropolished 316L), nickel, chromium, copper, glass, Teflon®, hastelloy, Vespel®, alumina, Kel-F, PEEK, Kynar®, silicon carbide or any other metallic, plastic or ceramic material, and variations and combinations are contemplated.

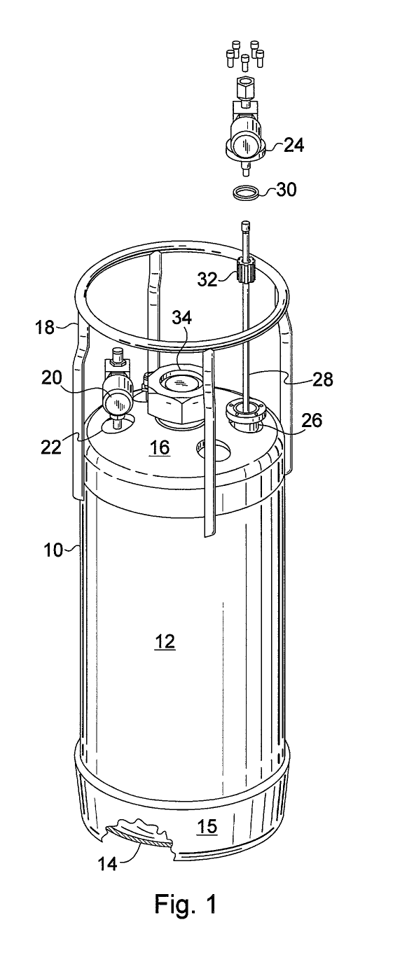

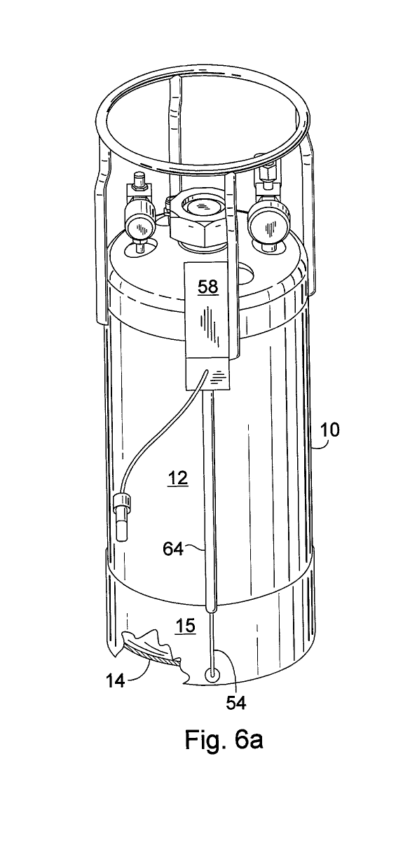

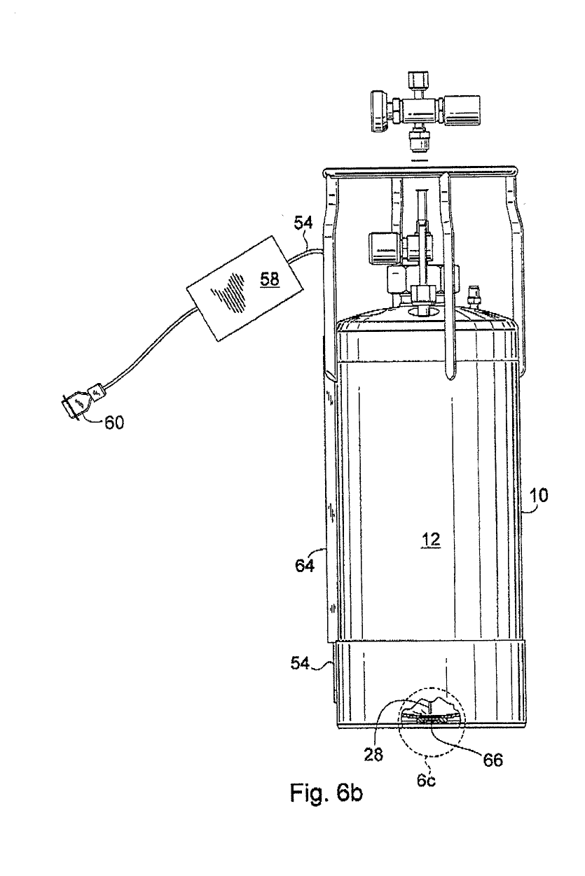

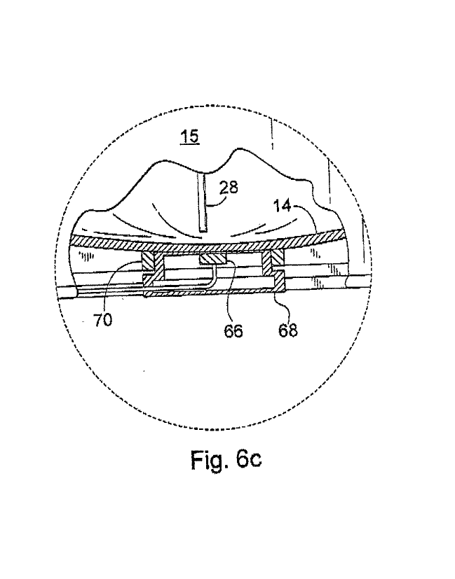

In FIG. 1, a Teflon diptube is connected to the container by using a flare nut. A quartz to stainless steel fitting can be used with a Teflon diptube to allow chemical to flow from the container, through the diptube, out of the outlet and its attendent valve when a pressure is applied to the container head space by an inert gas pressure source connected to the valved inlet of the container. FIG. 1 is a partially exploded view which shows a container 10, with a side surface or wall 12, a bottom or bottom surface 14 (in partial section) inside skirt 15 and attached to the lower or lowest most circumferential edge of side surface 12, a top or top surface 16, a chime ring assembly 18 for manually handling the container and protecting the valve and inlet/outlet assemblies, an inlet pneumatic valve 20 connected to an inlet 22 (valved inlet) typically connected to a source of inert pressurized gas (i.e., nitrogen, helium) to pressurize the headspace above the liquid level of the high purity liquid chemical to drive chemical out the diptube, an outlet 26 with a removable diptube 28 (in this instance Teflon or similar inert plastic) having a flare nut 32, a metallic seal 30 that seals outlet valve 24 to the outlet 26 (valved outlet) and a main orifice for filling and service 34. Flare nut 32 is connected to a quartz fitting bonded to the meal flange on the outlet and outlet valve assembly to make a Teflon to quartz to stainless steel connection. The Teflon diptube is removable from the container and disposable so that a new diptube can be used during refurbishing of the same material or a different material. The diptube 28 has one end having the flare nut 32 and an other end which ends very near the bottom of the container, shown in FIG. 6B, so as to remove most of the liquid high purity chemical during pressurization of the liquid's headspace.

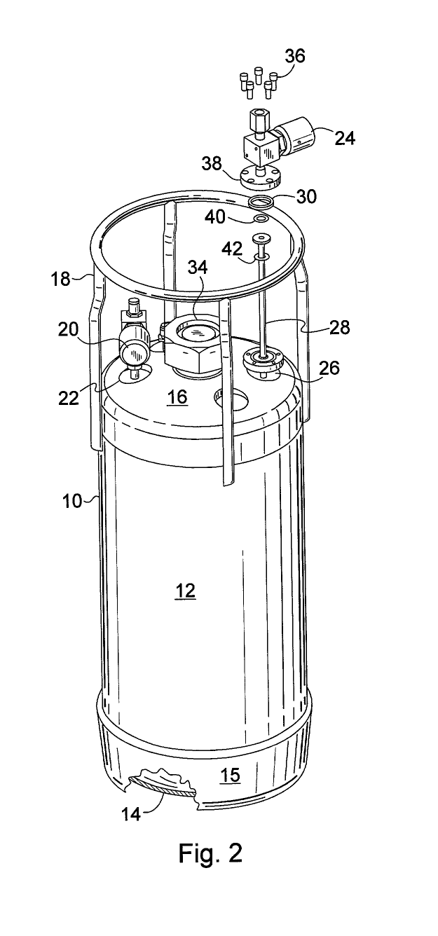

In another embodiment of the diptube removable fastening, an O-ring and metal seal are used. The O-rings, metal gasket and dip tube are assembled as shown in FIG. 2, where similar parts to FIG. 1 bear similar part numbers and will not necessarily be repeated in the description herein. Tightening the bolts 36 on the flange 38 creates an elastomer seal 40 between the diptube and the container, and also creates a full metal seal 30 between the chemical and the environment. Elastomeric seal 42 on the diptube 28 provides sealing for the diptube to the container.

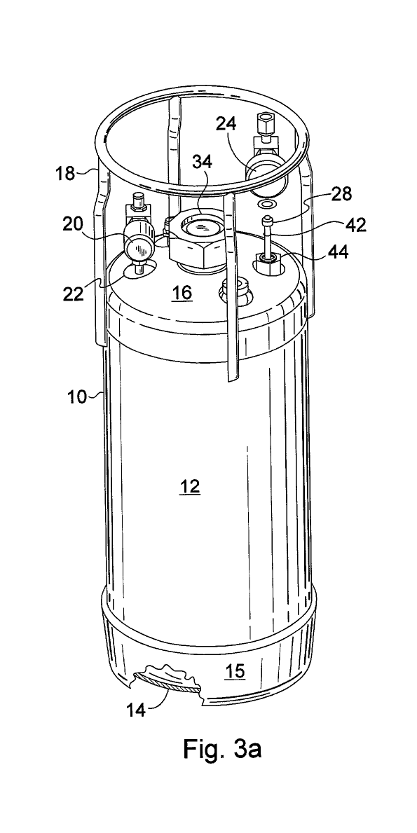

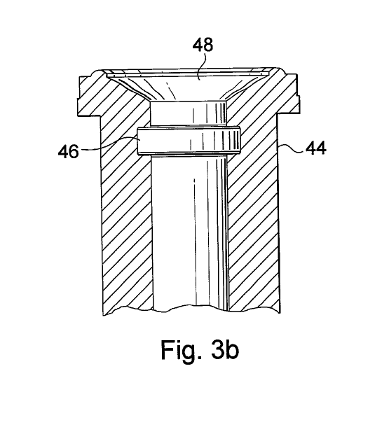

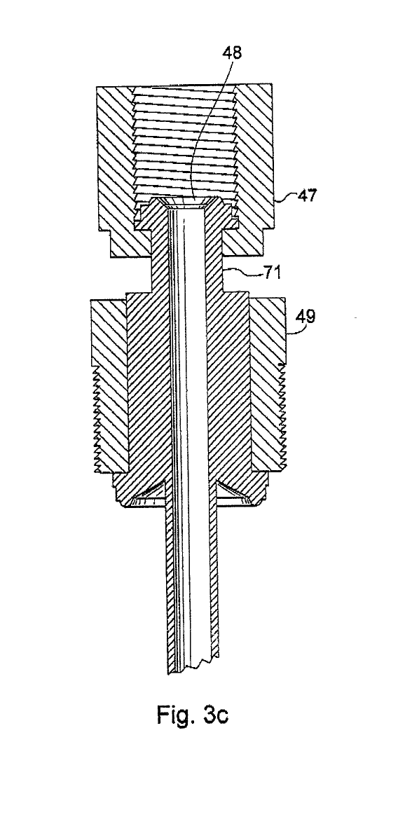

FIG. 3A illustrates a similar concept (where similar parts to FIG. 1 bear similar part numbers and will not necessarily be repeated in the description herein), except only one O-ring 42 is required and the metal seal is a standard VCR fitting 44 with O-ring gland 46 and VCR® gland surface 48, per FIG. 3B. For certain materials, such as Teflon®, Kynar®, PEEK and Vespel®, the diptube itself could be used to make the seal between the mating VCR glands and no O-ring would need to be used. FIG. 3C illustrates a similar concept, except a specially designed VCR® gland fitting with a diptube 71 incorporated, metal gaskets, are used to seal both the diptube to the container and protect the container from the environment. Nuts 47 and 49 affix diptube 71 to an output and the container, respectively. This is a preferred method for attaching this diptube 71.

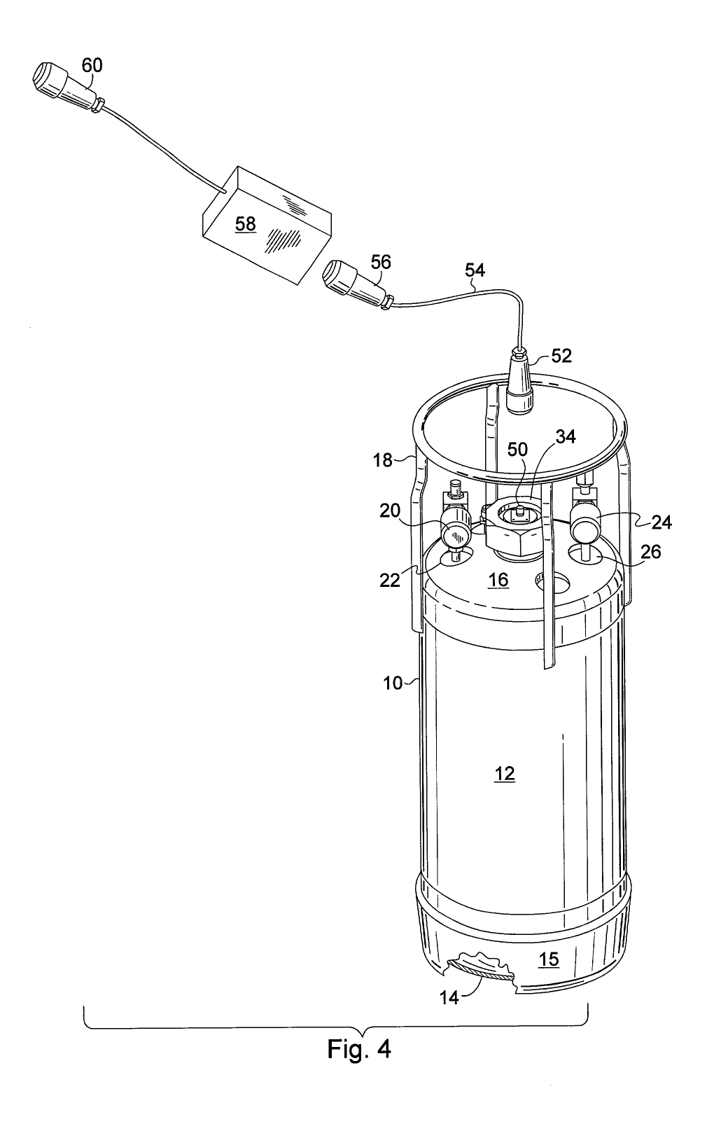

The level sensor of the present invention can be placed on various external non-chemical wetted surfaces of the container. FIG. 4 (where similar parts to FIG. 1 bear similar part numbers and will not necessarily be repeated in the description herein), shows the container 10. An ultrasonic level sensor 50 is permanently attached to the large nut or plug closing off main orifice 34 (in this instance, the plug or nut is considered part of the external surface). Level sensor 50 is connected to an outside controller, not shown, by connector 54 having plugs 52 and 56. Plug 56 allows the output of level sensor 50 to be inputted to signal power source 58, which in turn communicates with a chemical delivery system by plug 60 which is using the container 10 to deliver high purity chemical to a furnace or tool, also not shown, or another container when container 10 is used as a bulk container to refill such other container.

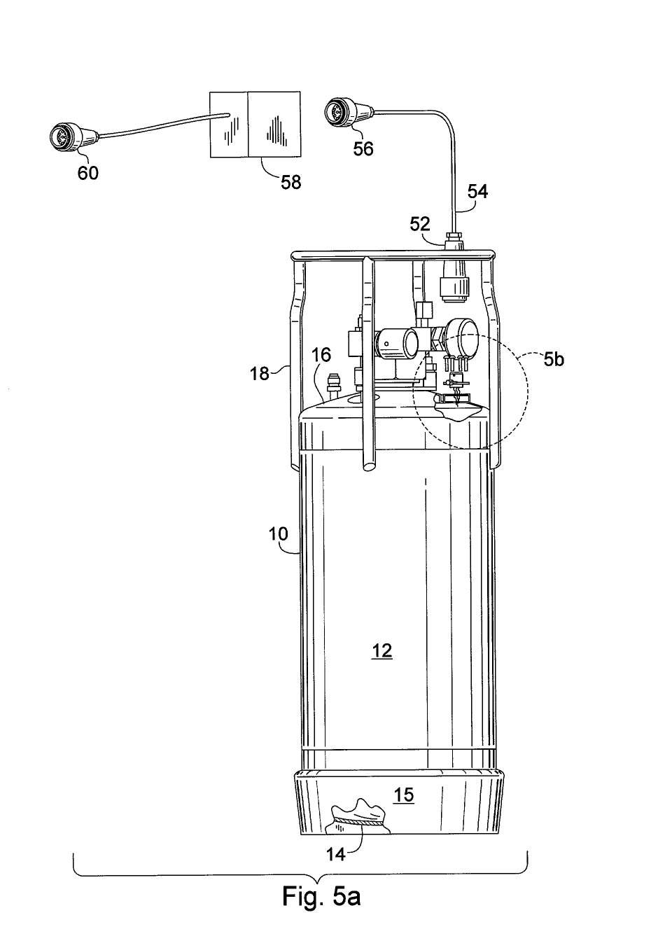

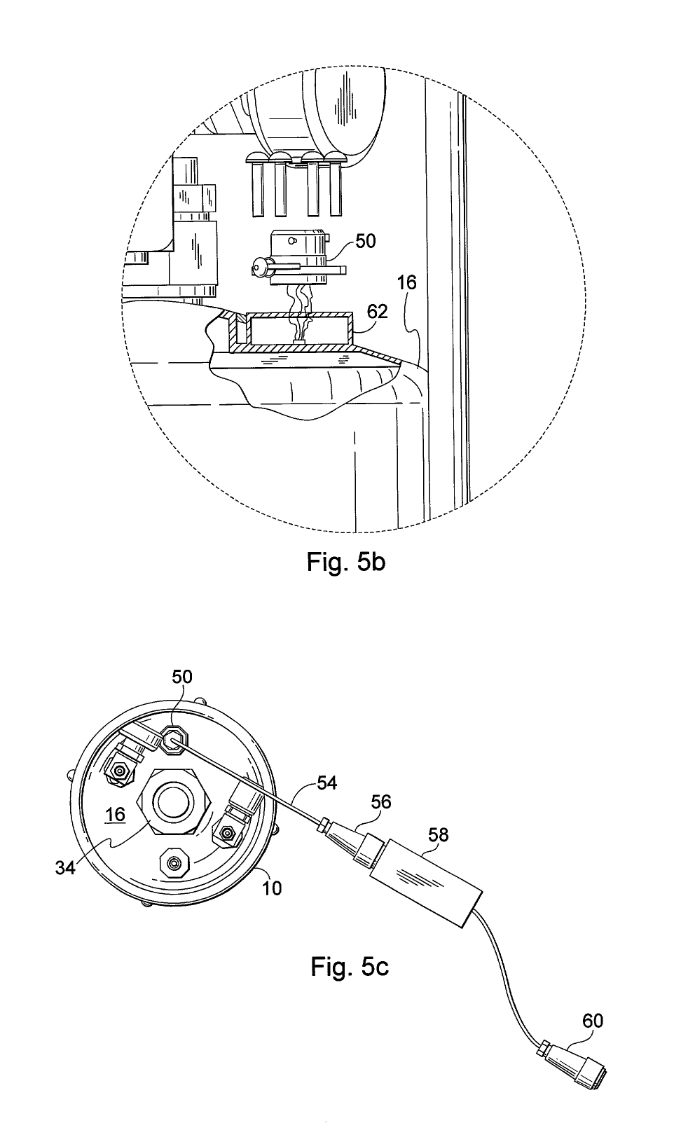

The container can be modified per FIG. 5A, B and C (where similar parts to FIG. 1 bear similar part numbers and will not necessarily be repeated in the description herein). In FIG. 5A, the ultrasonic level sensor 50 is attached to a special fitting or well 62 fabricated on the top surface 16 of the container 10. This is not centrally located, as in FIG. 4 where the sensor was on the central main orifice. Again, in FIG. 5A, B and C, similar parts bear similar part numbering. FIG. 5B shows a partial closeup sectional of FIG. 5A, wherein the placement of the sensor 50 to its fitting 62 and the top surface 16 of the container 10 can be appreciated. FIG. 5C shows a plan view of container 10 depicting the offset location of sensor 50 on the top surface 16 of of the container in relation to the main orifice 34.

In FIG. 6A, another embodiment of the present invention's level sensor placement (where similar parts to FIG. 1 bear similar part numbers and will not necessarily be repeated in the description herein), the level sensor can view the high purity chemical in the container 10 through the bottom surface 14 by use of a preferably welded internally threaded stub cylinder or mounting 70 of FIG. 6C (a partial sectional view of FIG. 6B), which engages a preferably externally threaded nut or bracket 68 connected to the level sensor fitting 66. FIG. 6A, a perspective view, shows that the connector 54 is contained in an external sleeve 64 on the side surface 12 of the container 10 to direct it down the side wall to the bottom of the container 10 in a safe and protected manner to the sensor fitting 66, described above with reference to FIG. 6C. Another depiction of the same embodiment is shown in FIG. 6B, an elevation view in partial section. Connector 54 is directed down sleeve 64 to the bottom of the container, which is shown in partial section to illustrate the central location of the sensor fitting 66 on the bottom surface 14 of the container 10. Preferably, the bottom surface 14 of the external surface of the container has a generally concave downward curvature from said side surface 12 and the sensor 66 is located at the lowest most point of the bottom surface 14 so as to read the liquid level to the lowest fill of liquid chemical in the container. This placement offers unique advantages because the sensor 66 is protected by the skirt 15 below the bottom surface 14, which skirt 15 is a continuation of side wall 12 below the bottom surface 14. The skirt and the bottom surface 14 form a protected cavity in which the sensor can safely reside, isolated from external disturbance and in a position to avoid mishandling during transport. Preferably, sensor 66 would not project below the plane representing the lowest most circumferential edge of the skirt 15, so as to avoid contact with any surface the container 10 may be placed upon. This placement also provides the best performance of the ultrasonic level sensor 66 to sense the level of the liquid chemical contained in the container 10, because the sound waves pass through the liquid to the interface of the liquid chemical and the gaseous headspace to reflect off the interface and be sensed upon reflection to the sensor 66. Liquid is a better conductor of sound waves than gas, so this placement affords the most precision and accuracy for an ultrasonic level sensor 66 to sense liquid level from an external surface of a container 10.

The difference between the FIGS. 1-5 embodiments and the FIG. 6 preferred embodiment is that the ultrasonic sensor in FIGS. 1-5 senses down through the gaseous head space of the container 10 to the liquid level of the high purity chemical, while the ultrasonic sensor in FIG. 6 senses up through the liquid content of the high purity chemical of the container 10. Note that the exact location of the sensor is specified in these various embodiments, but the present invention contemplates all equivalent positions including, but not limited to, flat surfaces on top, sides or bottom of container; curved surfaces on the top, sides or bottom of container; and the top, sides or bottom of any removable caps and/or flanges and/or openings that may exist on the container.

In both described versions, the ultrasonic signal is transmitted through the container and bounced off the surface or interface of the liquid high purity chemical and the gaseous headspace above the liquid surface in the container 10. The level is based on the speed of sound in the gas and/or liquid chemical. The signal would be adjustable for different blanket gases used. Appropriate ultrasonic level sensors are available commercially, such as the ML101 from Cosense, Inc. located at 155 Ricefield Lane, Hauppage, N.Y. 11788.

The present invention affords some significant advantages over the prior art in high purity chemical storage and dispensing. The diptube is completely removable from the container during the refurbishing process. The diptube can be metallic, plastic or ceramic or any material compatible with process chemicals used. The removable diptube allows for more thorough cleaning, when and if the container is refurbished. It also allows for other materials from which to fabricate the diptube. One of the more interesting materials for fabrication is silicon carbide. This material is well known as a high purity, non-particulating material in the semiconductor industry. This design would allow the use of a silicon carbide diptube.

In addition, the ultrasonic level sensor is a continuous sensing device, providing specific liquid chemical level detail at all levels, but it can also be discrete in nature, providing data only at levels predetermined by appropriate input of setpoints, programming or electrical monitoring. It is also completely outside the container. This non-intrusive level sensor will allow for higher chemical purity, because it removes one more source of contamination. Also, making the level sensor completely removable from the container will allow replacement of the level sensor in the field if the level sensor fails whether the container is inservice or not.

The present invention has been set forth with regard to several preferred embodiments, however the full scope of the present invention should be ascertained by the claims which follow.

1. A container for high purity chemicals having a metallic shell, an inlet, an outlet, a level sensor on an external surface of said shell for determining the amount of high purity chemical in said container and a diptube connected to said outlet through which high purity chemical can be dispensed from said container by connection to a downstream high purity chemical delivery system.

2. The container of claim 1 wherein said inlet and said outlet each have a valve for controlling fluid flow through said inlet and outlet.

3. The container of claim 2 wherein said valves are pneumatic valves capable of being operated by remote automated control.

4. The container of claim 1 wherein said diptube is removeably attached to said outlet at one end of said diptube and another end of said diptube ends near a bottom inside surface of said shell.

5. The container of claim 1 wherein said level sensor is located on a top side of said external surface of said container.

6. The container of claim 1 wherein said level sensor is located on a bottom surface of said external surface of said container.

7. The container of claim 1 wherein said level sensor is removably attached to said external surface of said container.

8. The container of claim 1 wherein said level sensor is permanently attached to said external surface of said container.

9. A container for high purity chemicals having a metallic shell, a valved inlet, a valved outlet, an ultrasonic level sensor removeably affixed to an external surface of said shell for determining the amount of high purity chemical in said container and a diptube removably connected to said outlet through which high purity chemical can be dispensed from said container by connection to a downstream high purity chemical delivery system.

10. The container of claim 9 wherein said level sensor is located on a bottom surface of said external surface of said container.

11. The container of claim 9 wherein said level sensor is removably attached to said external surface of said container.

12. A container for high purity chemicals comprising a metallic shell with an external surface comprising a top surface, a side surface and a bottom surface, a valved inlet, a valved outlet, an ultrasonic level sensor removeably affixed to the external top surface of said shell for determining the amount of high purity chemical in said container and a diptube removably connected to said outlet through which high purity chemical can be dispensed from said container by connection to a downstream high purity chemical delivery system.

13. A container for high purity chemicals comprising a metallic shell with an external surface comprising a top surface, a side surface and a bottom surface, a valved inlet, a valved outlet, an ultrasonic level sensor removeably affixed to the external bottom surface of said shell radially inside a skirt of said container and located above the plane defined by the bottom circumferential lower edge of said skirt, for determining the amount of high purity chemical in said container and a diptube removably connected to said outlet through which high purity chemical can be dispensed from said container by connection to a downstream high purity chemical delivery system.

14. A container for high purity chemicals having a metallic shell with an external surface comprising a top surface, a side surface and a bottom surface, a valved inlet, a valved outlet, an ultrasonic level sensor removeably affixed to an external side surface of said shell for determining the amount of high purity chemical in said container and a diptube removably connected to said outlet through which high purity chemical can be dispensed from said container by connection to a downstream high purity chemical delivery system.

15. A container for high purity liquid chemical having a metallic shell with an external surface comprising a top surface, a side surface and a bottom surface, a pneumatically valved inlet, a pneumatically valved outlet, a charge of high purity liquid chemical, an ultrasonic level sensor removeably affixed to an external surface of said shell for determining the amount of high purity chemical in said container and a diptube removably connected to said outlet through which high purity liquid chemical can be dispensed from said container by connection to a downstream high purity chemical delivery system.

16. The container of claim 15 wherein said diptube is connected to said outlet by the metal to metal seal of a VCR gland.

17. The container of claim 15 wherein said diptube is connected to said outlet by an elastomeric seal between an outer wall of said dip tube and an inner diameter of said outlet of said container.

18. The container of claim 15 wherein said diptube is connected to said outlet by a metal to metal seal of said outlet and a flange on said diptube.

19. The container fo claim 13 wherein said sensor is located on the lowest most point of said bottom surface of said external surface.

20. The container of claim 19 wherein said bottom surface of said external surface has a generally concave downward curvature from said side surface.
